(19) United States
(12) Patent Application Publication
(10) Pub. No.: US 2012/0183384 A1
(43) Pub. Date: Jul. 19, 2012

(54) MARINE DEBRIS GRAPPLE DEVICE AND METHOD

(76) Inventor: Tor G. Vincent, Northport, NY (US)

(21) Appl. No.: 13/351,193

(22) Filed: Jan. 16, 2012

Related U.S. Application Data
(60) Provisional application No. 61/433,473, filed on Jan. 17, 2011.

(51) Int. Cl. B66C 1/34; B63B 27/00; B65G 67/60

(52) U.S. Cl. 414/803; 294/66.1

(57) ABSTRACT

A marine debris grapple apparatus and method gives largely increased bottom coverage, as compared to conventional marine debris grapples, while providing shock absorption and a release mechanism from heavy snags. The device is engineered to the working loads of the specific vessel to provide maximum efficiency and safety. The device includes a tow line, a weight at the connection of the tow line with the main line, and a plurality of grapples attached to the main line via a grapple line. The combination of increased coverage, shock absorption and a release mechanism, together with a specific tow patters, results in a tremendous efficiency over conventional grappling methods.

### CROSS-REFERENCE TO RELATED APPLICATIONS

This application claims the benefit of priority of U.S. provisional patent application No. 61/433,473, filed Jan. 17, 2011, the contents of which are herein incorporated by reference.

### BACKGROUND OF THE INVENTION

The present invention relates to marine debris grapple device and method and, more particularly, to a device and method for grappling marine debris off the seafloor.

Grappling marine debris off the seafloor is a time consuming activity and includes many dangerous abrupt stops and lost equipment when hooking into overly large debris. Conventional grappling methods use a single grappling hook which has limited bottom coverage. A single grappling hook, by itself, provides no shock absorption when it encounters a large snag.

As can be seen, there is a need for an improved grappling apparatus and method.

### SUMMARY OF THE INVENTION

In one aspect of the present invention, a marine debris grapple apparatus comprises a weight; a mainline in contact with the weight; and at least one grapple hook in contact with the mainline, the grapple hook including a grapple line designed to have a lesser breaking strength than the breaking strength of the mainline.

In another aspect of the present invention, a marine debris grapple attachment comprises a tow line adapted to attach to a surface vessel on a first tow line end; a weight attached to a second tow line end; a mainline attached to the weight at a first end thereof; a plurality of grapple lines attached to the mainline; and a plurality of grapple hooks attached to the plurality of grapple lines.

In a further aspect of the present invention, a method for collecting debris from a seafloor comprising attaching a plurality of grapple hooks to a mainline via a grapple line; attaching an end of the mainline to a weight; attaching a tow line from the weight to a surface vessel; releasing a plurality of grapple hooks into a body of water; moving the surface vessel along the surface of a body of water and causing the weight and grapple hooks to drag along the seafloor; and lifting the weight off the seafloor when debris is caught by one of the grapple hooks, wherein the lifting of the weight provides shock absorption.

These and other features, aspects and advantages of the present invention will become better understood with reference to the following drawings, description and claims.

### BRIEF DESCRIPTION OF THE DRAWINGS

FIG. 1 is a side view of a marine debris grapple apparatus in use according to an exemplary embodiment of the present invention;

FIG. 2 is a detailed side view of a portion of the marine debris grapple apparatus of FIG. 1;

FIG. 3 is a detailed side view of the portion of FIG. 2, showing a weight raised when, for example, a grapple hook latches onto an object;

FIG. 4 is a top view of a portion of the marine debris grapple hook of FIG. 1, with one grapple approaching one object and a second grapple hook attached to a second object;

FIG. 5 is a top view of the marine debris grapple apparatus of FIG. 1 moving in a sweep pattern to search a seafloor; and

FIG. 6 is a top view of a dual marine debris grapple system according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a marine debris grapple apparatus and method that gives largely increased bottom coverage, as compared to conventional marine debris grapples, while providing shock absorption and a release mechanism from heavy snags. The device is engineered to the working loads of the specific vessel to provide maximum efficiency and safety. The device includes a tow line, a weight at the connection of the tow line with the main line, and a plurality of grapples attached to the main line via a grapple line. The combination of increased coverage, shock absorption and a release mechanism, together with a specific tow patters, results in a tremendous efficiency over conventional grappling methods.

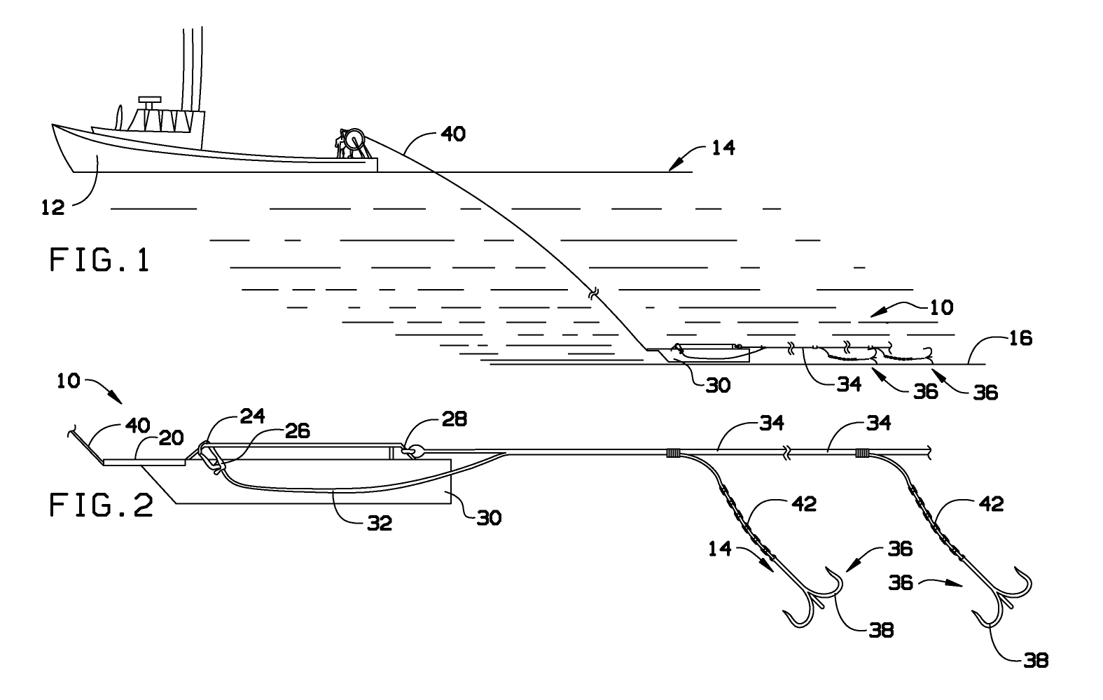

Referring to FIGS. 1 through 4, a tow line 40 may run from a boat 12 to a weight 30. The weight 30 is adapted to stay on the seafloor 16 while towing a normal load. Typically, the length of the tow line 40 may be at least twice the depth of the water 14. The amount of ballast needed in the weight 30 is directly related to the drag of the complete apparatus 10. For example, a large amount of boats have trouble going slow enough to tow a conventional grapnel while staying in gear. Constant clutching in and out of gear is undesirable. Different classes of vessels with different horsepower and tonnage will require a basic weight range. For example, for a 40 foot, 16 GRT lobster boat with 375 hp, the weight 30 needs to be typically from about 100 to about 125 pounds with an 8-10 grapnel rig to stay in gear at low idle.

A mainline 34 may be attached to the weight 30 and may trail behind along the seafloor 16. Like the tow line 40, the mainline 34 should have a strength that is a multiple of a safe working load of the boat 12. Grapple line 42 may attach the grapnels 36 to the mainline 34. The grapple lines 42 may be from about 5 to about 10 feet long and may be weaker (having a lower breaking strength, for example) than the mainline 34, but stronger than the safe working load of the boat 12.

The grapnels 36 may be attached to the grapple lines 42 at intervals, typically even intervals, to provide consistent coverage and timing on the haul back. For example, the grappling assembly 10 may include nine grapnels 36 spaced about 60 feet apart. The grapnels 36 may have from about 3 to about 6 hooks 38. The hooks 38 are typically made of steel that can withstand bending and re-bending. The bend release rate of a single hook should be below the safe working load of the boat 12. This will release a load that cannot be lifted. This may also allow passing through large debris and only catching the size objects desired. For example, the grapnel hook 36 may comprise a ⅜ inch mild steel round rod when the grappling assembly 10 is designed for retrieving lost lobster traps using a 40 foot lobster boat with a rope hauler that can lift 800 pounds.

In the event that two or more hooks snag on an immovable object, the boat may power up and snap off the grapple line 42. The lost grapnel 36 can be replaced later while the rig remains functional and intact. The grapple line 42 may comprise a rope, a cable, a chain, or the like, and may be of smaller dimension than the mainline 34.

The weight 30 may comprise a steel weight, for example, designed to bring the mainline 34 and the grapnel 36 to the seafloor 16. The weight 30 may be heavy enough to stay on the seafloor 16 at tow speed. For example, the weight 30 may be about 125 pounds when the tow speed is about 2 knots.

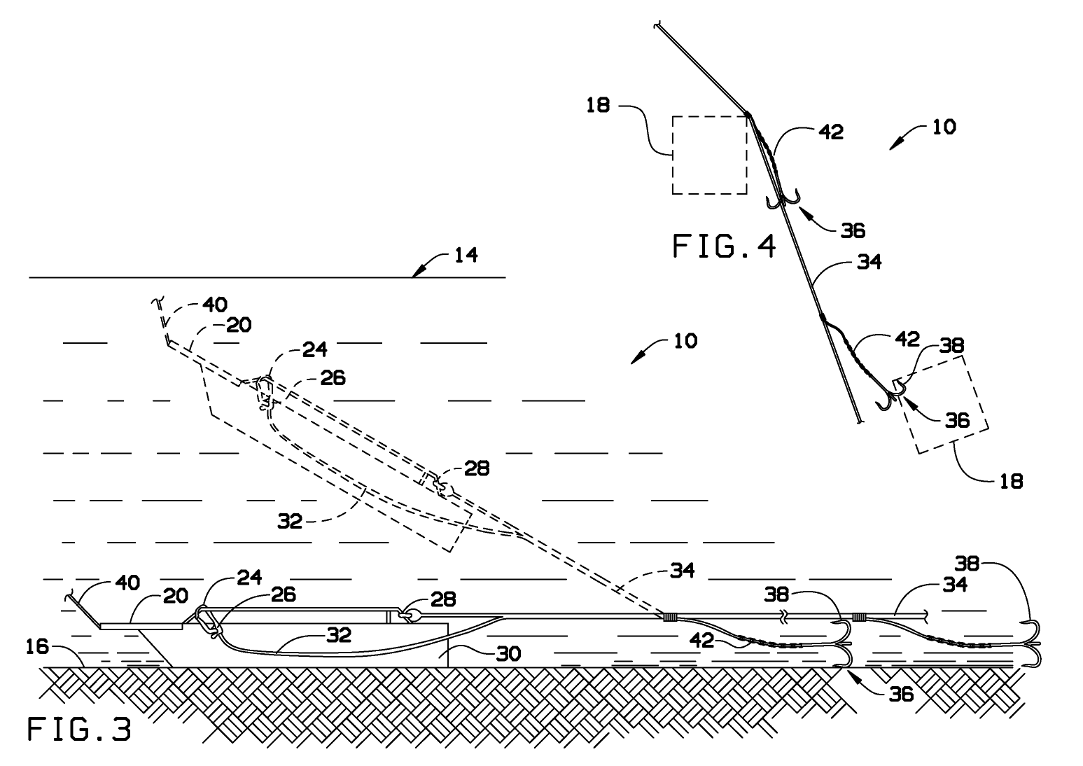

The weight 30 may be designed to pass over debris ahead of the grapnels 36 and may serve as a shock absorber when an object 18 is hooked. The weight 30 may lift up off the bottom during a heavy snag, as shown in FIG. 3, to provide shock absorption. The shock absorption may be a function of the tow line length and the length between the weight and the first heavy snagged hook. More length typically gives softer absorption. As the assembly 10 is towed in an arc, the mainline 34 slides across the bottom until a piece of debris 18 is contacted. Then, the mainline 34 slides along the debris 18, leading a grapple hook 38 into contact. Once the hook 38 grabs the debris 18, it stalls momentarily then begins slowly increasing strain as the assembly 10 first straightens then lifts the weight 30 up into a straight line from the hook 38 to the boat 12. This effect helps break the debris 18 free from the suction of the bottom. This slow pull and transition of strain greatly reduces the force that is needed to accelerate the debris 18 up to tow speed, thus allowing the use of hooks with a lower release weight which helps ease the release of hooks from debris beyond the safe working loads of the vessel. Once the debris 18 gets moving, the assembly 10 may return to an arc shape. The vessel 12 may continue towing to gather more than one piece of debris 18 in a multiple grapple assembly 10. The debris 18 on the hook will tend to bump around other debris and leave it for the next available hook. This ability to continue towing is especially effective for small vessels with light winches seeking to gather many small pieces of debris.

The weight 30 may include one or more attachment points. For example, the weight 30 may include a tow line coupler 20 for attaching the towline 40, a mainline coupler 28 for attaching the mainline 34, and a lift strap coupler 24 for attaching a lift strap clip 26 of the lift strap 32. The tow line coupler 20 may be positioned towards the front of the weight 30 and the mainline coupler 28 may be positioned towards the back end. The tow line coupler 20 and the mainline coupler 28 may be positioned on the same side of the weight 30 to minimize twisting.

The tow line 40 may comprise a tow rope or cable from the boat or vessel 12 and may be attached to the front of the weight 30, as shown in FIG. 3. The mainline 34 may be attached towards the back end of the weight 30. The towline 40 and mainline 34 each may comprise a cable, a rope, a chain, or the like. The lift strap 32 may be useful while bringing the grappling assembly 10 back on board.

The mainline 34 may be in contact with the weight 30 and may be designed to extend outward behind the weight 30. The length of the mainline 34 may vary with application and may depend on the desired number of grapnels 36 and the size of the area to be searched.

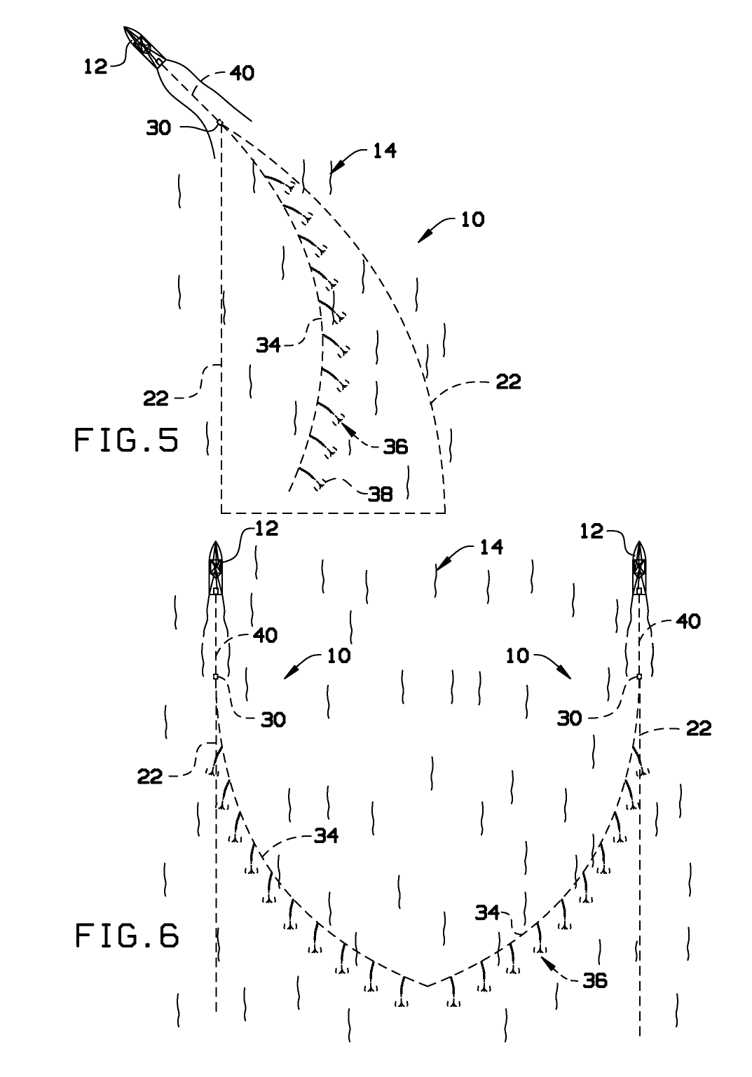

During use, the grappling assembly 10 can be towed in a slight arc, as shown in FIG. 5, so that the mainline 34 sweeps the bottom and guides the grapnels 36 to debris. Using multiple grapnels 36 and sweeping a wide path with the mainline 34 may provide for expanded lane coverage 22. Depending on the size of debris targeted, the grappling assembly 10 can be hauled back when one or more of the grapnel hooks 36 are loaded. When oversize debris is hooked, as described above, the grapnel hooks 36 can bend straight and release the debris with no loss of equipment or immediate haul back required. The grapnel hooks 36 may be re-bent aboard using a 16 inch pipe by hand, for example.

Referring now to FIG. 6, two grappling assemblies 10 may be attached together and pulled by two vessels 12 to create a wide lane 22 that does not require the vessels 12 to turn, as shown in FIG. 5. This configuration may be useful for “fine cleaning” of the seafloor or when a detailed search grid is set up for a complete seafloor coverage, for example.

It should be understood, of course, that the foregoing relates to exemplary embodiments of the invention and that modifications may be made without departing from the spirit and scope of the invention as set forth in the following claims.

What is claimed is:

1. A marine debris grapple apparatus comprising:
a weight;
a mainline in contact with the weight; and
at least one grapple hook in contact with the mainline, the grapple hook including a grapple line designed to have a lesser breaking strength than the breaking strength of the mainline.

2. The marine debris grapple apparatus of claim 1, further comprising a plurality of grapple hooks spaced along the mainline.

3. The marine debris grapple apparatus of claim 2, wherein the plurality of grapple hooks are equally spaced apart along the mainline.

4. The marine debris grapple apparatus of claim 1, further comprising a lift strap having a first end attached to a lift strap attachment disposed on the weight and a second end attached to the mainline.

5. The marine debris grapple apparatus of claim 1, further comprising a tow line running from a tow line attachment on the weight to a surface vessel.

6. A marine debris grapple attachment comprising:
a tow line adapted to attach to a surface vessel on a first tow line end;
a weight attached to a second tow line end;
a mainline attached to the weight at a first end thereof;
a plurality of grapple lines attached to the mainline; and
a plurality of grapple hooks attached to the plurality of grapple lines.

7. The marine debris grapple apparatus of claim 6, wherein the grapple line has a lesser breaking strength than a breaking strength of the mainline.

8. The marine debris grapple apparatus of claim 6, further comprising a lift strap having a first end attached to a lift strap attachment disposed on the weight and a second end attached to the mainline.

9. A method for collecting debris from a seafloor, comprising:
attaching a plurality of grapple hooks to a mainline via a grapple line;
attaching an end of the mainline to a weight;
attaching a tow line from the weight to a surface vessel;
releasing a plurality of grapple hooks into a body of water;
moving the surface vessel along the surface of a body of water and causing the weight and grapple hooks to drag along the seafloor; and
lifting the weight off the seafloor when debris is caught by one of the grapple hooks, wherein the lifting of the weight provides shock absorption.

10. The method of claim 9, further comprising using two surface vessels to each drag a grapple assembly along the seafloor, the grapple assemblies connected together at a distal end thereof.
